(19) United States
(12) Patent Application Publication
(10) Pub. No.: US 2023/0406267 A1
(43) Pub. Date: Dec. 21, 2023

(54) CLEANING DEVICE FOR CLEANING OPTICAL DEVICE COVER

(71) Applicant: Eul Soup SIM, Gwangmyeong-si (KR)

(72) Inventor: Eul Soup SIM, Gwangmyeong-si (KR)

(21) Appl. No.: 18/033,519

(22) PCT Filed: Aug. 25, 2021
(86) PCT No.: PCT/KR2021/011356

§ 371 Date: Apr. 24, 2023

(30) Foreign Application Priority Data
Oct. 28, 2020 (KR) 10-2020-0141578

(51) Int. Cl. B60S 1/48; G02B 27/00; B05B 7/04; B60S 1/50; B60S 1/52

(52) U.S. Cl. CPC B60S 1/481; G02B 27/0006; B05B 7/0483; B60S 1/50; B60S 1/52

(57) ABSTRACT

The present invention relates to a cleaning device for an optical device cover, which, by placing a fluid nozzle below a curved part, can achieve a better Coanda effect without impacting the function of an optical device, and is characterized by comprising: a cover having a curved part; a housing in which an optical device is disposed inside of the cover; a fluid pipe installed on one side surface of the cover and supplying fluid; and a fluid nozzle for injecting the fluid into the cover.

### TECHNICAL FIELD

The present invention relates to a cleaning device for an optical device cover, and more specifically, to a cleaning device for an optical device cover that is capable of cleaning the optical device cover using the Coanda effect so that the optical device cover can be cleanly kept.

### BACKGROUND ART

At present, auxiliary systems having the functions of assistance for a driver, while a vehicle is being driven, have been increasingly mounted on the vehicle. Examples of such auxiliary systems include optical or optoelectronic sensors, such as cameras, laser-based sensors, and infrared sensors, and through them, information of the surrounding environments of the vehicle is acquired.

The sensors are provided with covers for transmitting light in a given restricted range, and the covers are generally transparent. Further, the auxiliary systems are mounted on the outside of the vehicle, and accordingly, if they are contaminated due to external causes or become deteriorated in their function, they have to be cleaned.

To solve such problems, one of conventional cleaning devices is disclosed in Korean Patent Application Laid-open No. 10-2019-0132511. A cleaning device as disclosed in the prior art technology is configured to allow a cleaning liquid jet to be located transversely with respect to an optical axis of a transparent element, but a nozzle is disposed on the side surface thereof, so that in the case of an optical camera, the nozzle may have a bad influence on the function of the optical camera and there are limitations in designing the cleaning device.

### PRIOR ART LITERATURE

### Patent Document

(Patent document 1) Korean Patent Application Laid-open No. 10-2019-0132511

### DISCLOSURE

### Technical Problem

Accordingly, the present invention has been made in view of the above-mentioned problems occurring in the related art, and it is an object of the present invention to provide a cleaning device for an optical device cover that is capable of placing a fluid nozzle below a curved part, thereby obtaining the Coanda effect more successfully, without having any bad influence on the function of an optical device.

### Technical Solution

To accomplish the above-mentioned objects, according to the present invention, there is provided a cleaning device for an optical device cover including: a cover having a transmitting part and a curved part disposed on the outer periphery of the transmitting part; a housing adapted to locate an optical device inside the cover; a fluid pipe located on one side surface of the cover to supply fluids; and a fluid nozzle for injecting the fluids into the cover.

The fluid nozzle may include a first fluid nozzle for injecting compressed air and a second fluid nozzle for injecting a liquid cleaning agent.

The compressed air may be supplied through the first fluid pipe and injected through the first fluid nozzle, and in addition, the cleaning device may further include a second fluid pipe for supplying the liquid cleaning agent and a second fluid nozzle for injecting the liquid cleaning agent.

The cleaning device may further include a straight line portion formed on the end of the curved part at the inside of the front end of the first fluid nozzle.

The first fluid nozzle may include a direction inducing part adapted to surround a given outer peripheral surface of the cover, while having a given gap between the straight line portion of the cover and the outside of the cover.

The first fluid nozzle may be lower in position than the cover.

The fluid nozzle may include a cleaning agent supply device for supplying the liquid cleaning agent to the second fluid pipe.

The cleaning agent supply device may include a body for storing the liquid cleaning agent, a supply valve for supplying the liquid cleaning agent to the second fluid pipe, and a vacuum line for transferring a vacuum to the body to supplement the liquid cleaning agent to the body.

The cleaning agent supply device may include a body in which the liquid cleaning agent is stored, a supply valve for supplying the liquid cleaning agent to the second fluid pipe, and a vacuum line for transferring a vacuum to the body to supplement the liquid cleaning agent to the body.

The cleaning agent supply device may further include a vacuum valve connected to the vacuum line to prevent a poppet valve from being open.

If the cleaning agent supply device is attached to the rear side of a vehicle, the cleaning agent supply device may further include a supply line for connecting a main liquid cleaning agent tank and the body to each other to receive the liquid cleaning agent.

The cleaning device may further include a controller for controlling the compressor and the cleaning agent supply device.

The controller may receive at least one or more signals from means for sensing the contamination of the transmitting part and thus controls the compressor.

### Advantageous Effects

As described above, the cleaning device for an optical device cover according to the present invention is configured to place the fluid nozzle below the curved part, thereby obtaining the Coanda effect more successfully, without having any bad influence on the function of the optical device.

### BRIEF DESCRIPTION OF DRAWINGS

FIG. 1 is a perspective view showing a cleaning device for an optical device cover according to the present invention.

FIG. 2 is a sectional view showing the cleaning device for an optical device cover according to the present invention.

FIG. 3 is an enlarged view showing a fluid nozzle of the cleaning device for an optical device cover according to the present invention.

FIG. 4 is an exemplary view showing a process for supplying a cleaning agent in the cleaning device for an optical device cover according to the present invention.

### EXPLANATIONS OF REFERENCE NUMERALS IN THE DRAWINGS

200: Cleaning device for an optical device cover
100: Cover 10: Transmitting part
20: Curved part 21: Straight line perpendicular to one end of curved part
30: Housing 31: Optical device
40: Fluid pipe 41: First fluid pipe 42: Second fluid pipe
50: Fluid nozzle 51: First fluid nozzle
52: Second fluid nozzle 53: Direction inducing part
60: Straight line part 70: Cleaning agent supply device
71: Body 72: Supply valve 73: Vacuum line
74: Vacuum valve 75: Poppet valve 76: Supply line
77: Main liquid cleaning agent tank

### BEST MODE FOR INVENTION

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

In the description, the thicknesses of the lines or the sizes of the components shown in the drawing may be magnified for the clarity and convenience of the description. Further, the terms as will be discussed later are defined in accordance with the functions of the present invention, but may be varied under the intention or regulation of a user or operator. Therefore, they should be defined on the basis of the whole scope of the present invention.

A term ‘and/or’ includes a combination of a plurality of relevant and described items or any one of a plurality of related and described items. When it is said that one element is described as being “connected” or “coupled” to the other element, one element may be directly connected or coupled to the other element, but it should be understood that another element may be present between the two elements. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

In the description, when it is said that a layer, a region, a pattern, or a structure is located “on” or “under” another layer, region, pattern, or structure, it means that one layer may come into contact with another layer as well as yet another layer may exist between the two layers. The relation between the layers is explained with reference to the drawings.

Hereinafter, an embodiment of the present invention will be described in detail with reference to the accompanying drawings.

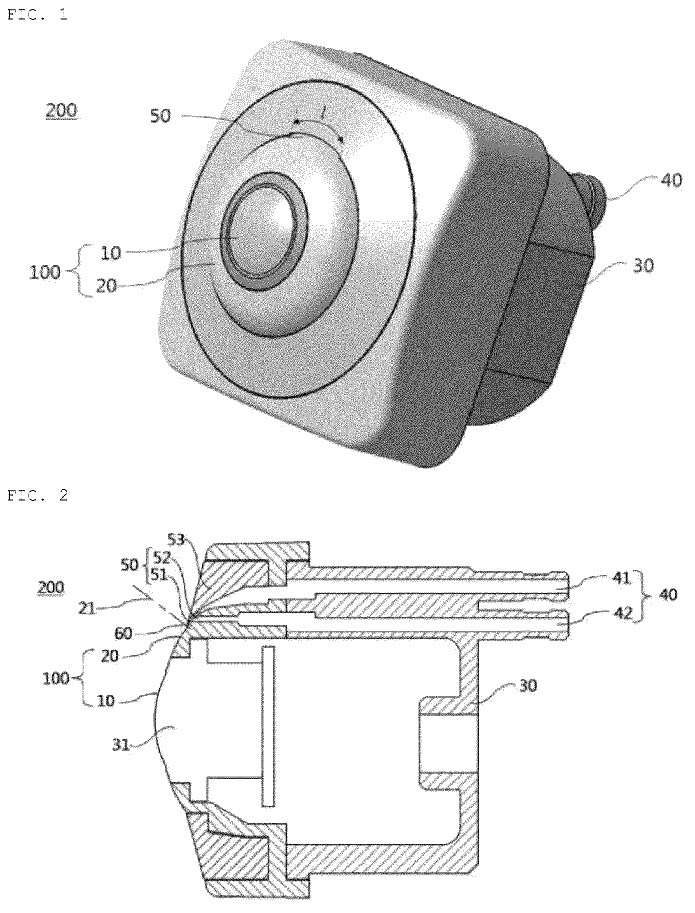

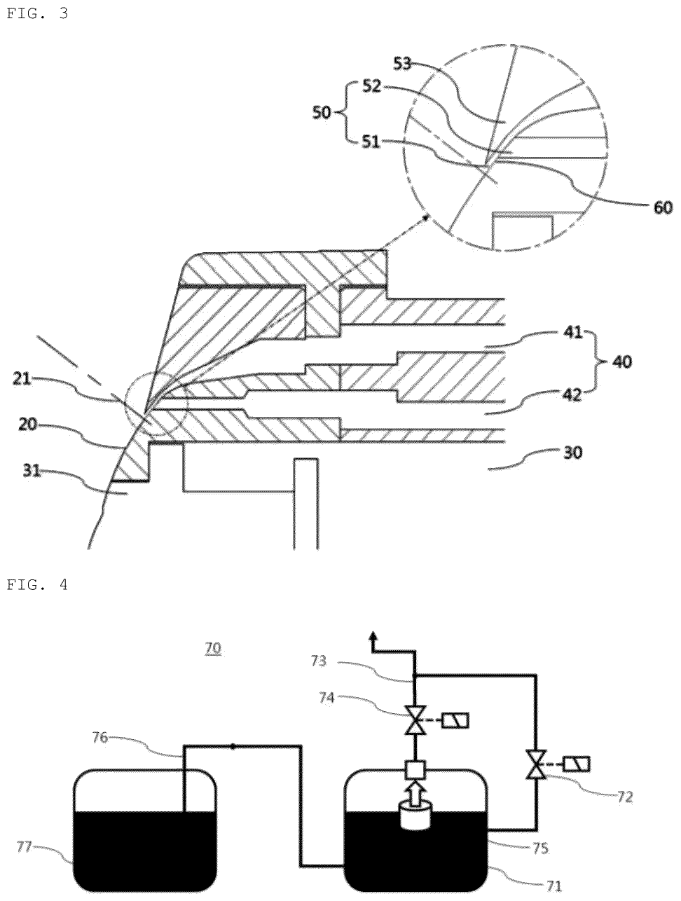

FIG. 1 is a perspective view showing a cleaning device for an optical device cover according to the present invention, FIG. 2 is a sectional view showing the cleaning device for an optical device cover according to the present invention, FIG. 3 is an enlarged view showing a fluid nozzle of the cleaning device for an optical device cover according to the present invention, and FIG. 4 is an exemplary view showing a process for supplying a cleaning agent in the cleaning device for an optical device cover according to the present invention.

As shown in FIGS. 1 and 2, a cleaning device 200 for an optical device cover according to the present invention includes a cover 100, a housing 30, a fluid pipe 40, and a fluid nozzle 50.

The cover 100 includes a transmitting part 10 and a curved part 20 formed on the outer periphery of the transmitting part 10, and the housing 30 is adapted to locate an optical device 31 inside the cover 100.

The fluid pipe 40 is located on one side surface of the cover 100 to supply fluids and includes a first fluid pipe 41 for supplying compressed air and a second fluid pipe 42 for supplying a liquid cleaning agent.

The fluid nozzle 50 serves to inject the fluids supplied from the fluid pipe 40 into a given side periphery of the curved part 20 of the cover 100 along the curved part 20. The fluid nozzle 50 includes a first fluid nozzle 51 for injecting the compressed air and a second fluid nozzle 52 for injecting the liquid cleaning agent. In this case, desirably, the second fluid nozzle 52 is located at the inside or outlet of the first fluid nozzle 51 whose static pressure is lower than the surround pressure because of a fast flow rate under Bernoulli principle. In this case, if the second fluid nozzle 52 is located at the outlet of the first fluid nozzle 51, it may be blocked by external foreign substances, and accordingly, the second fluid nozzle 52 is desirably located at the inside of the first fluid nozzle so that it can be prevented from external contamination even though it has a static pressure higher than that when it is located at the outlet of the first fluid nozzle 51.

The Coanda effect is achieved more successfully when the fluids flow along the curved part 20, without having any flow separation. So as to allow the Coanda effect to be achieved more stably, that is, to provide flow stability so that no flow separation occurs, the inventor has found that through a number of tests, it is advantageous to have a straight line portion 60 formed on one end of the curved part 20 at the inside of the front end of the first fluid nozzle 51. An explanation of the straight line portion 60 will be given in detail later with reference to FIG. 3.

Further, the first fluid nozzle 51 includes a direction inducing part 53 adapted to surround a given outer peripheral surface of the cover 100, while having a given gap between the straight line portion 60 of the cover 100 and the outside of the cover 100.

So as to allow the fluid to be injected into the outside through the given gap between the direction inducing part 53 and the straight line portion 60, the direction inducing part 53 serve to induce the fluid to flow along the curved part 20, so that the fluid flows along the cover 100 having the curved part 20 disposed thereon.

Referring to FIG. 1, in this case, a length 1 of a chord of a slit of the fluid nozzle 50 is similar to a diameter of the transmitting part 10. Desirably, it is advantageous that the length 1 of the chord is 80 to 100% of the diameter of the transmitting part 10. If the length 1 is shorter than the above-mentioned range, the fluid injected from the nozzle cleans only a given area of a transmitting part of a cleaning object, and contrarily, if the length 1 is longer than the above-mentioned range, a large amount of fluid is unnecessarily injected.

As shown in FIG. 3, the cleaning device 200 according to the present invention desirably has the straight line portion 60 formed on one end of the curved part 20 at the inside of the front end of the first fluid nozzle 51.

If the straight line portion 60 is not formed, the first fluid nozzle 51 is located on the curved part 20, and in this case, it is hard to design the gap of the nozzle accurately. Further, the fluid is unstable in a flow direction thereof so that it may not flow along the curved part 20, that is, it may cause flow separation. So as to solve such problems, there is a need to stabilize the flow direction of the fluid before the fluid is injected from the first fluid nozzle 51, and accordingly, it is desirable that the straight line portion 60 be formed at the inside of the first fluid nozzle 51 and the front end of the first fluid nozzle 51 be located at the straight line portion 60.

Referring to FIGS. 2 and 3, the fluid pipe 40 includes the first fluid pipe 41 and the second fluid pipe 42. The compressed air is supplied to the first fluid pipe 41 and injected into the outside through the first fluid pipe 41. So as to supply the compressed air, in this case, a typical compressor is used, and an explanation of the compressor will be avoided. Further, the present invention may be applied to a head lamp of a vehicle as well as an optical device such as a camera. In the case of using a dynamic pressure of air caused by the speed of the vehicle while the vehicle is being driven, no separate compressor is required.

Further, the liquid cleaning agent is supplied to the second fluid pipe 42 and injected into the outside through the second fluid pipe 42. In this case, a liquid pump and a cleaning agent supply device 70 are needed to supply the liquid cleaning agent.

To supply the liquid cleaning agent, a conventional liquid pump may be used. According to a process of supplying the liquid cleaning agent, the liquid cleaning agent can be supplied even to the cleaning agent supply device using the static pressure lower than the surrounding pressure because of a fast flow rate under Bernoulli principle.

Referring to FIG. 4, the cleaning agent supply device 70 includes a body 71 for storing the liquid cleaning agent, a supply valve 72 for supplying the liquid cleaning agent to the second fluid pipe 42, and a vacuum line 73 for transferring a vacuum to the body 71 to supplement the liquid cleaning agent to the body 71. In this case, the body 71 may be a tank in which a washing liquid is stored according to the position of the cleaning device 200, and in this case, hereinafter, the tank is called a main liquid cleaning agent tank 77.

In this case, the cleaning agent supply device 70 further includes a vacuum valve 74 connected to the vacuum line 73 to prevent a poppet valve 75 from being open.

The supply valve 72 constantly operates or intermittently operates according to the degree of contamination of the transmitting part 20, and as the level of the liquid cleaning agent stored in the body 71 becomes low by the operation of the supply valve 72, the poppet valve 75 may be open undesirably. Accordingly, the vacuum valve 74 is connected to the vacuum line 73, and in this case, the vacuum valve 74 has to operate oppositely to the supply valve 72. Instead of the poppet valve 75, in this case, a level sensor and a washing liquid filling controller may be included.

In this case, if the cleaning agent supply device 70 is attached to the rear side of the vehicle so that it is hard to supply the liquid cleaning agent because of the static pressure lowered around the first fluid nozzle 51 under Bernoulli principle, the body 71 in which the liquid cleaning agent is stored is located around the cleaning device 200, and the cleaning agent supply device 70 further includes a supply line 76 for connecting the main liquid cleaning agent tank 77 disposed in an engine room of the vehicle and the body 71 to each other to receive the liquid cleaning agent (washing liquid). Further, a liquid pump is used to supplement the liquid cleaning agent to the body 71 from the main liquid cleaning agent tank 77 through the supply line 76, and otherwise, the static pressure lowered around the first fluid nozzle 51 under Bernoulli principle may be utilized.

The supply line 76 serves to supplement the liquid cleaning agent to the body 71 from the main liquid cleaning agent tank 77 by means of the vacuum force of the vacuum line 73. If the liquid cleaning agent is filled in the body 71, the poppet valve 75 floats to automatically block the vacuum line 73, thereby preventing the liquid cleaning agent from being filled anymore in the body 71.

Hereinafter, the compressor, the cleaning agent supply device 70, and the liquid pump are called generally ‘fluid supply devices’.

To control the fluid supply devices, further, the cleaning device 200 further includes a controller and at least one or more sensors or means for recognizing weather and the degree of contamination of the transmitting part 20. The sensors for recognizing weather include a rain sensor, a vibration sensor, etc.

For example, the rain sensor detects a reflection ratio value of infrared rays sensed on a glass plate of a vehicle, and the vibration sensor detects a value of vibrations sensed on the glass plate of the vehicle. It is determined that precipitation exists through the values detected from the rain sensor and the contamination sensor, and according to the determined results, the fluid supply devices are controlled, thereby saving an amount of energy consumed and remarkably reducing noise occurring.

In this case, the sensor for recognizing weather, the contamination sensor, and the vibration sensor are included as the sensors, but the sensors may represent devices for detecting various physical quantities, without being limited thereto.

As mentioned above, the cleaning device 200 for the optical device cover according to the present invention receives the sensed signals and thus controls one or more fluid supply devices to allow the fluids to be supplied to the fluid pipe 40. In this case, if the fluid is the compressed air, it is supplied to the first fluid pipe 41, and if it is the liquid cleaning agent, it to the second fluid pipe 42. Further, the supplied fluid flows along the direction inducing part 53 and is injected into the outside through the gap between the direction inducting portion 53 and the straight line portion 60. In specific, the fluid is injected into the given side periphery of the curved part 20 of the cover 100 along the curved part 20, thereby cleaning the cover 100.

In this case, cleaning steps are divided according to the degrees of contamination. For example, at a low degree of contamination wherein fine particles exist on the transmitting part 10, the compressed air is injected for a short period of time so that the cover 100 is cleaned. At a moderate degree of contamination wherein raindrops fall or a vehicle is driven on an unpaved road, the compressed air is continuously injected so that the cover 100 is cleaned. Lastly, at a high degree of contamination wherein muddy water or wet dust exists on the transmitting part 10, the compressed air and the liquid cleaning agent are mixedly used. In specific, the compressed air is primarily injected for a short period of time, and next, it is secondarily injected together with the liquid cleaning agent. After that, the injection of the liquid cleaning agent is stopped, and the compressed air is injected again for a short period of time, thereby enhancing a cleaning efficiency with a small amount of cleaning agent.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A cleaning device for an optical device cover, comprising:
a cover having a transmitting part and a curved part disposed on the outer periphery of the transmitting part;
a housing adapted to locate an optical device inside the cover;
a first fluid pipe located on one side surface of the cover to supply a fluid; and
a first fluid nozzle for injecting the fluid into the cover,
wherein the first fluid nozzle serves to inject the fluid received from the first fluid pipe into a given side periphery of the curved part of the cover along the curved part.

2. The cleaning device according to claim 1, further comprising a second fluid pipe for supplying a liquid cleaning agent and a second fluid nozzle for injecting the liquid cleaning agent.

3. The cleaning device according to claim 1, further comprising a straight line portion formed on the end of the curved part inside the front end of the first fluid nozzle.

4. The cleaning device according to claim 1, wherein the first fluid nozzle comprises a direction inducing part adapted to surround a given outer peripheral surface of the cover, while having a given gap between the straight line portion of the cover and the outside of the cover.

5. The cleaning device according to claim 1, wherein the first fluid nozzle is lower in position than the cover.

6. The cleaning device according to claim 2, wherein the second fluid pipe further comprises a liquid pump for supplying the liquid cleaning agent.

7. The cleaning device according to claim 2, further comprising a compressor for compressing the fluid of the first fluid pipe and a cleaning agent supply device for supplying the liquid cleaning agent to the second fluid pipe.

8. The cleaning device according to claim 7, wherein the cleaning agent supply device comprises a body for storing the liquid cleaning agent, a supply valve for supplying the liquid cleaning agent to the second fluid pipe, and a vacuum line for transferring a vacuum to the body to supplement the liquid cleaning agent to the body.

9. The cleaning device according to claim 8, wherein the cleaning agent supply device further comprises a vacuum valve connected to the vacuum line to prevent a poppet valve from being open.

10. The cleaning device according to claim 8, wherein if the cleaning agent supply device is attached to the rear side of a vehicle, the cleaning agent supply device further comprises a supply line for connecting a main liquid cleaning agent tank and the body to each other to receive the liquid cleaning agent.

11. The cleaning device according to claim 7, further comprising a controller for controlling the compressor and the cleaning agent supply device.

12. The cleaning device according to claim 11, wherein the controller receives at least one or more signals from means for sensing the contamination of the transmitting part and thus controls the compressor.
